(19) United States
(12) Patent Application Publication
(10) Pub. No.: US 2015/0379265 A1
(43) Pub. Date: Dec. 31, 2015

(54) Systems And Methods For Preventing Code Injection In Virtualized Environments

(71) Applicant: Bitdefender IPR Management Ltd., Nicosia (CY)

(72) Inventors: Andrei V. LUTAS, Satu Mare (RO); Sandor LUKACS, Floresti (RO)

(21) Appl. No.: 14/318,719

(22) Filed: Jun. 30, 2014

(51) Int. Cl. G06F 21/56; G06F 9/455

(52) U.S. Cl. CPC G06F 21/56; G06F 9/45558; G06F 2221/034; G06F 2009/45587

(57) ABSTRACT

Described systems and methods allow protecting a host system from malicious injection of code and/or data. A memory introspection engine operates below an operating system (OS), having higher processor privileges than the OS. The memory introspection engine is configured to selectively block the copying of memory between a source process and a destination process, thus preventing the injection of code and/or data, particularly from or into user-mode processes. To prevent inter-process memory copying, some embodiments hook a native OS function carrying out such copy operations. A subsequent call to the hooked function may either carry out or block the requested copy operation, according to a set of decision criteria based on the identity of the source process and/or the identity of the destination process.

### BACKGROUND

The invention relates to systems and methods for protecting computer systems from malware.

Malicious software, also known as malware, affects a great number of computer systems worldwide. In its many forms such as computer viruses, worms, rootkits, and spyware, malware presents a serious risk to millions of computer users, making them vulnerable to loss of data and sensitive information, identity theft, and loss of productivity, among others.

A typical way to carry out malicious activities in a host system involves injecting code and/or data into a process already executing on the respective system. By executing within the memory space of the targeted process, such malicious code may have direct access to the resources of the targeted process, and may conduct various activities masquerading as the respective process. In one such example, to steal sensitive data such as credit card details of a user accessing an e-commerce website, a malware agent may inject a piece of code into the web browser, the respective piece of code configured to record data input by the user. In another example, malware trying to hide a file on a hard drive of the host system may inject a piece of code into a file management process, such as Windows Explorer®.

Another common type of malware is used to circumvent copyright protection of digital data. Such malware may be configured to copy data, such as user keys or protected content, from a targeted process.

Hardware virtualization technology allows the creation of simulated computer environments commonly known as virtual machines, which behave in many ways as physical computer systems. In typical modern applications, such as server consolidation and infrastructure-as-a-service (IAAS), several virtual machines may run simultaneously on the same physical machine, sharing the hardware resources among them, thus reducing investment and operating costs. Each virtual machine may run its own operating system and/or software applications, separately from other virtual machines.

Due to the steady proliferation of malware, each such virtual machine potentially requires malware protection, including protection against malicious code injection and data theft. There is considerable interest in developing efficient, robust, and scalable anti-malware solutions for hardware virtualization platforms.

### SUMMARY

According to one aspect, a host system comprises a hardware processor configured to operate a virtual machine and a memory introspection engine executing outside the virtual machine. The virtual machine comprises a virtualized processor and is configured to employ the virtualized processor to execute a source process and a destination process. The memory introspection engine is configured to intercept an attempt to copy a content of memory from a virtual memory space of the source process to a virtual memory space of the destination process, and to identify the source and destination processes according to the attempt. The memory introspection engine is further configured to, in response to identifying the source and destination process, selectively block the attempt according to a selection criterion determined according to at least one member of a group consisting of an identity of the source process and an identity of the destination process.

According to another aspect, a method comprises employing at least one hardware processor of a host system to execute a memory introspection engine, the memory introspection engine executing outside of a virtual machine exposed by the host system. The virtual machine comprises a virtualized processor and is configured to employ the virtualized processor to execute a source process and a destination process. Executing the memory introspection engine comprises intercepting an attempt to copy a content of memory from a virtual memory space of the source process to a virtual memory space of the destination process, and identifying the source and destination processes according to the attempt. Executing the memory introspection engine further comprises, in response to identifying the source and destination processes, selectively blocking the attempt according to a selection criterion determined according to at least one member of a group consisting of an identity of the source process and an identity of the destination process.

According to another aspect, a non-transitory computer-readable medium stores instructions which, when executed by at least one hardware processor of a host system, cause the host system to form a memory introspection engine executing outside a virtual machine exposed by the host system. The virtual machine comprises a virtualized processor, and is configured to employ the virtualized processor to execute a source process and a destination process. The memory introspection engine is configured to intercept an attempt to copy a content of memory from a virtual memory space of the source process to a virtual memory space of the destination process, and to identify the source and destination processes according to the attempt. The memory introspection engine is further configured to, in response to identifying the source and destination processes, selectively block the attempt according to a selection criterion determined according to at least one member of a group consisting of an identity of the source process and an identity of the destination process.

### BRIEF DESCRIPTION OF THE DRAWINGS

The foregoing aspects and advantages of the present invention will become better understood upon reading the following detailed description and upon reference to the drawings where:

FIG. 1 shows an exemplary set of virtual machines exposed by a hypervisor executing on a host system, and a memory introspection engine protecting the set of virtual machines according to some embodiments of the present invention.

FIG. 2 shows an exemplary hardware configuration of the host system according to some embodiments of the present invention.

FIG. 3 shows an exemplary configuration of virtualized hardware exposed to a guest virtual machine according to some embodiments of the present invention.

FIG. 4 illustrates an exemplary hierarchy of software objects executing on the host system at various processor privilege levels, including a set of objects protected from malware according to some embodiments of the present invention.

FIG. 5 shows an exemplary mapping of memory addresses in some embodiments of the present invention.

FIG. 6 shows a typical sequence of steps carried out by malware to inject code and/or data into a destination process.

FIG. 7 shows an exemplary sequence of steps performed by the memory introspection engine to protect a guest virtual machine according to some embodiments of the present invention.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Unless otherwise specified, a process is an instance of a computer program, such as an application or a part of an operating system, and is characterized by having at least an execution thread and a virtual memory space assigned to it by the operating system, wherein a content of the respective virtual memory space includes executable code. Unless otherwise specified, a page represents the smallest unit of virtual memory that can be individually mapped to a physical memory of a host system. Computer readable media encompass non-transitory media such as magnetic, optic, and semiconductor storage media (e.g. hard drives, optical disks, flash memory, DRAM), as well as communication links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

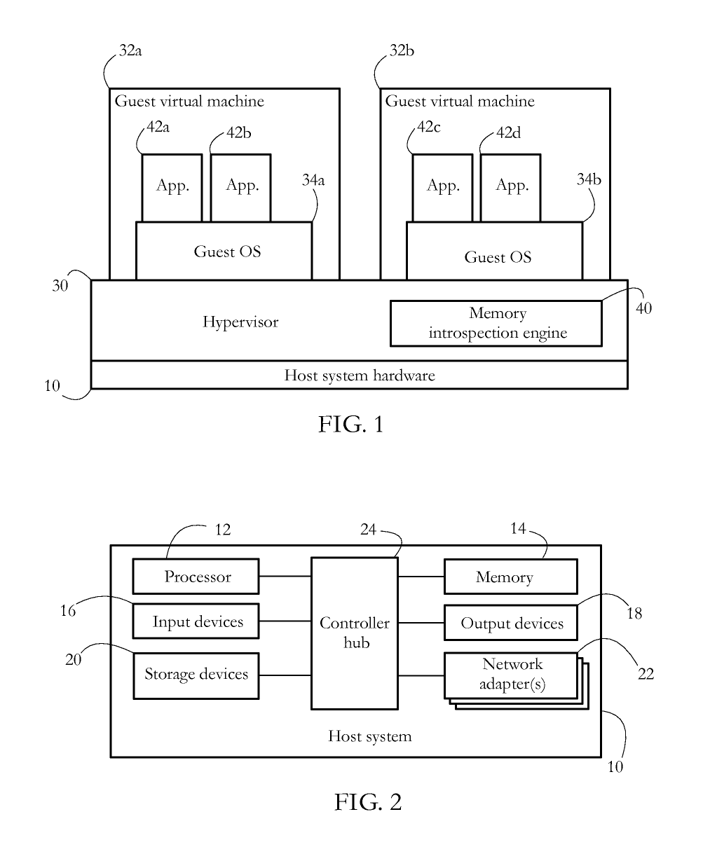

FIG. 1 shows an exemplary configuration of a host system 10 running a hardware virtualization platform and protected from malware according to some embodiments of the present invention. Host system 10 may represent a corporate computing device such as an enterprise server, or an end-user device such as a personal computer, tablet computer, or smartphone. Other exemplary host systems include entertainment devices such as TVs and game consoles, or any other device having a memory and a processor, and requiring malware protection. In the example of FIG. 1, host system 10 executes a set of guest virtual machines 32a-b, exposed by a hypervisor 30. A virtual machine (VM) comprises an abstraction, e.g., a software emulation, of an actual physical machine/computer system, the VM capable of running an operating system and other applications. Hypervisor 30 includes software configured to create a plurality of virtualized devices, such as a virtual processor and a virtual memory controller, and to present such virtualized devices to software in place of the real, physical devices of host system 10. Such operations of hypervisor 30 are commonly known in the art as exposing a virtual machine. In some embodiments, hypervisor 30 allows a multiplexing (sharing) by multiple virtual machines of hardware resources of host system 10. Hypervisor 30 may further manage such multiplexing so that each VM operates independently and is unaware of other VMs executing concurrently executing on host system 10. Examples of popular hypervisors include the VMware vSphere™ from VMware Inc. and the open-source Xen hypervisor, among others.

Each VM 32a-b may execute a guest operating system (OS) 34a-b, respectively. A set of exemplary applications 42a-d generically represent any software application, such as word processing, image processing, media player, database, calendar, personal contact management, browser, gaming, voice communication, data communication, and anti-malware applications, among others. Operating systems 34a-b may comprise any widely available operating system such as Microsoft Windows®, MacOS®, Linux®, iOS®, or Android™, among others. Each OS provides an interface between applications executing within a virtual machine and the virtualized hardware devices of the respective VM. In the following description, software executing on a virtual processor of a virtual machine is said to execute within the respective virtual machine. For instance, in the example of FIG. 1, applications 42a-b are said to execute within guest VM 32a, while applications 42c-d are said to execute within guest VM 32b. In contrast, hypervisor 30 is said to execute outside, or below, guest VMs 32a-b.

In some embodiments, hypervisor 30 includes a memory introspection engine 40, configured to perform anti-malware operations as described further below. Engine 40 may be incorporated into hypervisor 30, or may be delivered as a software component distinct and independent from hypervisor 30, but executing at substantially similar processor privilege level as hypervisor 30. A single engine 40 may be configured to malware-protect multiple VMs executing on host system 10.

FIG. 2 shows an exemplary hardware configuration of host system 10. System 10 comprises a set of physical devices, including a processor 12, a memory unit 14, a set of input devices 16, a set of output devices 18, a set of storage devices 20, and a set of network adapters 22, all connected by a controller hub 24. In some embodiments, processor 12 comprises a physical device (e.g. multi-core integrated circuit formed on a semiconductor substrate) configured to execute computational and/or logical operations with a set of signals and/or data. In some embodiments, such logical operations are delivered to processor 12 in the form of a sequence of processor instructions (e.g. machine code or other type of software). Memory unit 14 may comprise volatile computer-readable media (e.g. RAM) storing data/signals accessed or generated by processor 12 in the course of carrying out instructions.

Input devices 16 may include computer keyboards, mice, and microphones, among others, including the respective hardware interfaces and/or adapters allowing a user to introduce data and/or instructions into host system 10. Output devices 18 may include display devices such as monitors and speakers, among others, as well as hardware interfaces/adapters such as graphic cards, allowing host system 10 to communicate data to a user. In some embodiments, input devices 16 and output devices 18 may share a common piece of hardware, as in the case of touch-screen devices. Storage devices 20 include computer-readable media enabling the non-volatile storage, reading, and writing of processor instructions and/or data. Exemplary storage devices 20 include magnetic and optical disks and flash memory devices, as well as removable media such as CD and/or DVD disks and drives. The set of network adapters 22 enables host system 10 to connect to a computer network and/or to other devices/computer systems. Controller hub 24 generically represents the plurality of system, peripheral, and/or chipset buses, and/or all other circuitry enabling the communication between processor 12 and devices 14, 16, 18, 20 and 22. For instance, controller hub 24 may include a memory controller, an input/output (I/O) controller, and an interrupt controller, among others. In another example, controller hub 24 may comprise a northbridge connecting processor 12 to memory 14 and/or a southbridge connecting processor 12 to devices 16, 18, 20, and 22.

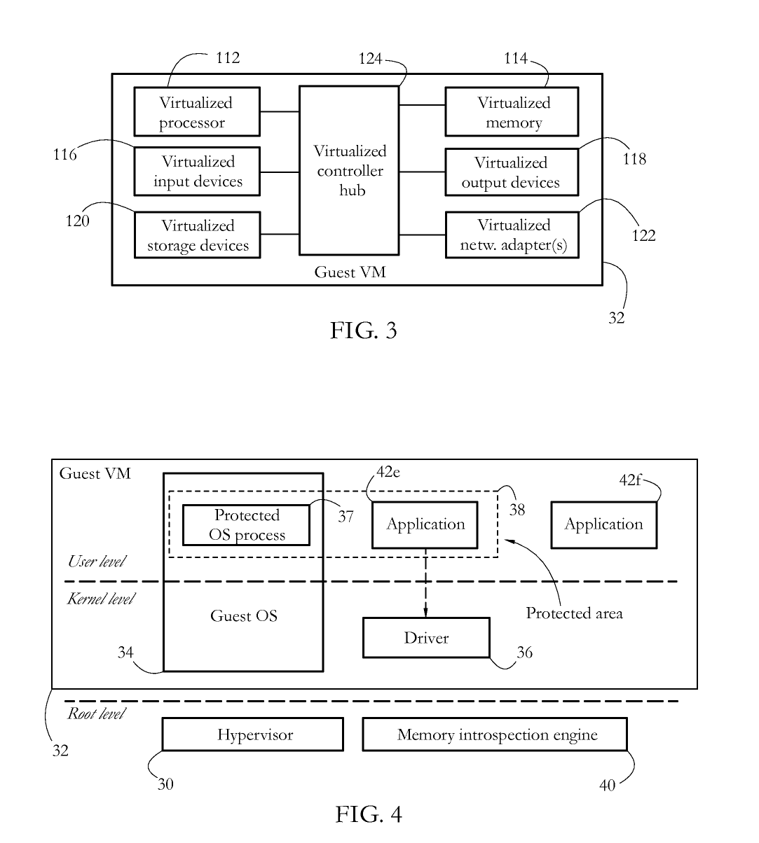

FIG. 3 shows an exemplary configuration of a virtual machine 32, as exposed by hypervisor 30. VM 32 may represent any of VMs 32a-b of FIG. 1. VM 32 includes a virtualized processor 112, a virtualized memory unit 114, virtualized input devices 116, virtualized output devices 118, virtualized storage 120, virtualized network adapters 122, and a virtualized controller hub 124. Virtualized processor 112 comprises an emulation of at least some of the functionality of processor 12, and is configured to receive for execution processor instructions forming part of software such as an operating system and other applications. Software using processor 112 for execution is deemed to execute within virtual machine 32. In some embodiments, virtualized memory unit 114 comprises addressable spaces for storing and retrieving data used by virtualized processor 112. Other virtualized devices (e.g., virtualized input, output, storage, etc.) emulate at least some of the functionality of the respective physical devices of host system 10. Virtualized processor 112 may be configured to interact with such devices as it would with the corresponding physical devices. For instance, software executing within VM 32 may send and/or receive network traffic via virtualized network adapter(s) 122. In some embodiments, hypervisor 30 may expose only a subset of virtualized devices to VM 32 (for instance, only virtualized processor 112, virtualized memory 114, and parts of hub 124). Hypervisor 30 may also give a selected VM exclusive use of some hardware devices of host system 10. In one such example, VM 32a (FIG. 1) may have exclusive use of input devices 16 and output devices 18, but lack a virtualized network adapter. Meanwhile, VM 32b may have exclusive use of network adapter(s) 22. Such configurations may be implemented, for instance, using VT-d® technology from Intel.

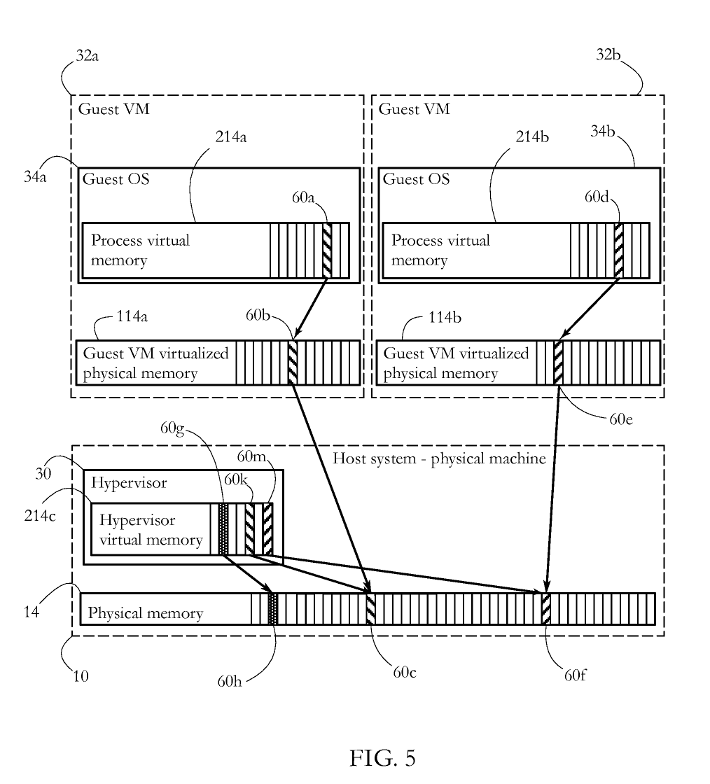

FIG. 4 illustrates an exemplary hierarchy of software objects executing on host system 10 according to some embodiments of the present invention. FIG. 4 is represented from the perspective of processor privilege levels, also known in the art as layers or protection rings. In some embodiments, hypervisor 30 takes control of processor 12 at the most privileged level (e.g., VMXroot on Intel platforms supporting virtualization, also known as ring-1, or root mode), thus creating a hardware virtualization platform exposed as virtual machine 32 to other software executing on host system 10. An operating system 34, such as guest OSs 34a-b in FIG. 1, executes within the virtual environment of VM 32, OS 34 having lesser processor privilege than hypervisor 30 (e.g., ring 0 or kernel mode). A set of applications 42e-f execute at lesser processor privilege than OS 34 (e.g., ring 3 or user mode). Parts of applications 42e-f may execute at kernel privilege level, for instance a driver 36 installed by application 42e. Some parts of OS 34 may execute in user mode (ring 3).

An exemplary driver 36 may perform anti-malware operations, and in some embodiments even collaborate with introspection engine 40. Such an anti-malware component executing within guest VM 32 may have some advantages. For instance, determining various information about running processes and threads may be substantially easier to do from within guest VM 32, than from the level of engine 40. In one example, driver 36 may identify processes currently running within VM 32. In another example, driver 36 may determine a memory address of a resource used by a process, and communicate the address to engine 40. In yet another example, driver 36 may receive a message from engine 40 and in response, display a malware warning message to a user of guest VM 32. Communication between components executing inside guest VM 32 and engine 40 may be carried out using any method known in the art of virtualization (for instance, via a dedicated section of memory accessible to both engine 40 and driver 36).

In some embodiments, introspection engine 40 executes substantially at the same processor privilege level as hypervisor 30 (e.g., ring-1 or root mode), and is configured to perform introspection of virtual machines executing on host system 10, such as VM 32. Introspection of a VM, or of a software object executing within the respective VM, may comprise analyzing a behavior of the respective software object. For instance, introspection may comprise detecting an action performed by the object (e.g., calling certain functions of the OS, accessing a registry of the OS, downloading a file from a remote location, writing data to a file, etc.). Introspection may further comprise determining addresses of memory sections containing parts of the software object, accessing the respective memory sections, and analyzing a content stored within the respective memory sections. Other examples of introspection include intercepting and/or restricting access to such memory sections, e.g., preventing the over-writing of code or data belonging to a protected process, and preventing the execution of code stored in certain memory pages. Yet another example of introspection comprises selectively denying the copying of code and/or data between distinct processes executing on the respective VM, as shown in detail below.

In some embodiments, memory introspection engine 40 sets up a protected area 38 comprising a set of processes selected for malware protection from a list of processes currently executing within guest VM 32. Protecting a process may comprise denying the copying of code and/or data to and/or from a virtual memory space of the respective process. In the example of FIG. 4, protected area 38 includes a protected OS process 37 and all processes of application 42e. In some embodiments, protected area 38 includes all processes executing at the user level of processor privilege (user mode, or ring 3). Each protected process may be identified, for instance, according to a unique identifier (e.g., process ID) assigned to the respective process by guest OS 34.

To select processes for protection, memory introspection engine 40 may access a list of processes currently executing within guest VM 32, the list maintained by guest OS 34, and select processes according to process type (e.g., browser, file manager, etc.), and/or according to other criteria. For instance, engine 40 may select a process for protection according to whether the respective process is user-defined, as opposed to being a part of guest OS 34 or of a predetermined set of trusted applications. In some embodiments, engine 40 may rely on a component from within VM 32 (e.g., on driver 36) to identify currently running processes. In another exemplary embodiment, memory introspection engine may hook an OS function responsible for inserting a process into the list of currently executing processes. An example of such a function is PspinsertProcess in Windows®. Similar functions exist in other operating systems, such as Linux®. Every time a process is launched, the respective hook may transfer execution to a handler routine of engine 40, thus notifying engine 40 of the launch. Engine 40 may then determine, for instance according to predetermined selection criteria, whether the currently launched process needs protection.

To be able to perform introspection of VM 32 in a configuration as illustrated in FIG. 1 (i.e., from outside the respective VM), some embodiments of engine 40 employ memory mapping structures and mechanisms of processor 12. Virtual machines typically operate with a virtualized physical memory (see, e.g., memory 114 in FIG. 3), also known in the art as guest-physical memory. Virtualized physical memory comprises an abstract representation of the actual physical memory 14, for instance as a contiguous space of addresses specific to each guest VM, with parts of said space mapped to addresses within physical memory 14 and/or physical storage devices 20. In systems configured to support virtualization, such mapping is typically achieved via dedicated data structures and mechanisms controlled by processor 12, known as second level address translation (SLAT). Popular SLAT implementations include extended page tables (EPT, on Intel® platforms), and nested page tables (NPT, on AMD® platforms). In such systems, virtualized physical memory may be partitioned in units known in the art as pages, a page representing the smallest unit of virtualized physical memory individually mapped to physical memory via mechanisms such as EPT and/or NPT, i.e., mapping between physical and virtualized physical memory is performed with page granularity. All pages typically have a predetermined size, e.g., 4 kilobytes, 2 megabytes, etc. The partitioning of virtualized physical memory into pages is usually configured by hypervisor 30. In some embodiments, hypervisor 30 also configures the EPT/NPT and therefore the mapping between physical memory and virtualized physical memory. The actual mapping (translation) of a virtualized physical memory address to a physical memory address may comprise looking up the physical memory address in a translation lookaside buffer (TLB) of host system 10. In some embodiments, address translation comprises performing a page walk, which includes a set of successive address look-ups in a set of page tables and/or page directories, and performing calculations such as adding an offset of a page to an address relative to the respective page.

In some embodiments, OS 34 configures a virtual memory space for a process such as applications 42e-f in FIG. 4, by maintaining a mapping (address translation) between the respective virtual memory space and the virtualized physical memory of VM 32, for instance using a page table mechanism. In some embodiments, the process virtual memory space is also partitioned into pages, such pages representing the smallest unit of virtual memory individually mapped to virtualized physical memory by OS 34, i.e., virtual to virtualized-physical memory mapping is performed with page granularity.

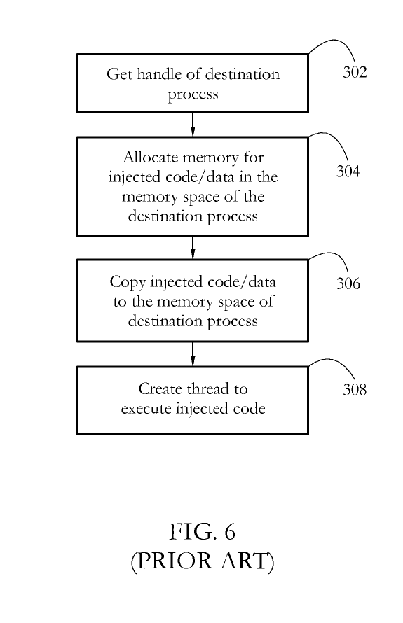

FIG. 5 illustrates an exemplary mapping (translation) of memory addresses in an embodiment as shown in FIG. 1. Following exposure by hypervisor 30, each guest VM 32a-b sees a virtualized physical memory space 114a-b, respectively, as its own physical memory space. A software object (e.g., a protected process) executing within guest VM 32a is assigned a virtual memory space 214a by guest OS 34a. When the software object attempts to access a content of an exemplary memory page 60a of space 214a, an address of page 60a is translated by the virtualized processor of guest VM 32 into an address of a page 60b of virtualized physical memory space 114a of VM 32, according to page tables configured and controlled by guest OS 34a. The address of page 60b is further mapped by physical processor 12 to an address of a page 60c within physical memory 14 of host system 10, for instance using SLAT means configured by hypervisor 30.

Meanwhile, guest OS 34b sets up a virtual memory space 214b for a software object executing within guest VM 32b. A page 60d within space 214b is mapped by the virtualized processor of VM 32b, for instance via page tables set up by OS 34b, to a page 60e of guest-physical space 114b. The address of page 60e is further translated by physical processor 12 to an address of a page 60f within physical memory, via SLAT configured by hypervisor 30.

In some embodiments, hypervisor 30 sets up its own virtual memory space 214c comprising a representation of physical memory 14, and employs a translation mechanism (for instance, page tables) to map addresses in space 214c to addresses in physical memory 14. In FIG. 5, such an exemplary mapping translates the address of a page 60k within virtual space 214c to the physical address of page 60c, and the address of a page 60m to the physical address of page 60f. Such mappings allow hypervisor 30 to manage (e.g., read from, write to, and control access to) memory pages belonging to software objects executing within various VMs running on host system 10.

FIG. 6 shows a typical sequence of steps performed by malware to inject code and/or data into a destination process, e.g., a browser. In a step 302, a (malicious) source process may obtain a handle of the destination process. In Windows®, for instance, step 302 may include a call to the OpenProcess function of the OS. Next, a step 304 allocates memory within the virtual memory space of the destination process, the allocated memory reserved for holding a section of injected code and/or data. In a step 306, the respective injected code and/or data is copied from the virtual memory space of the source process to the allocated section of the memory space of the destination process. A step 308 then creates a remote thread configured to execute the injected code. In some embodiments, memory introspection engine 40 protects the source and/or destination process from malware by preventing the execution of step 306, i.e., by preventing the copying of code and/or data between the source and destination processes, as shown in more detail below.

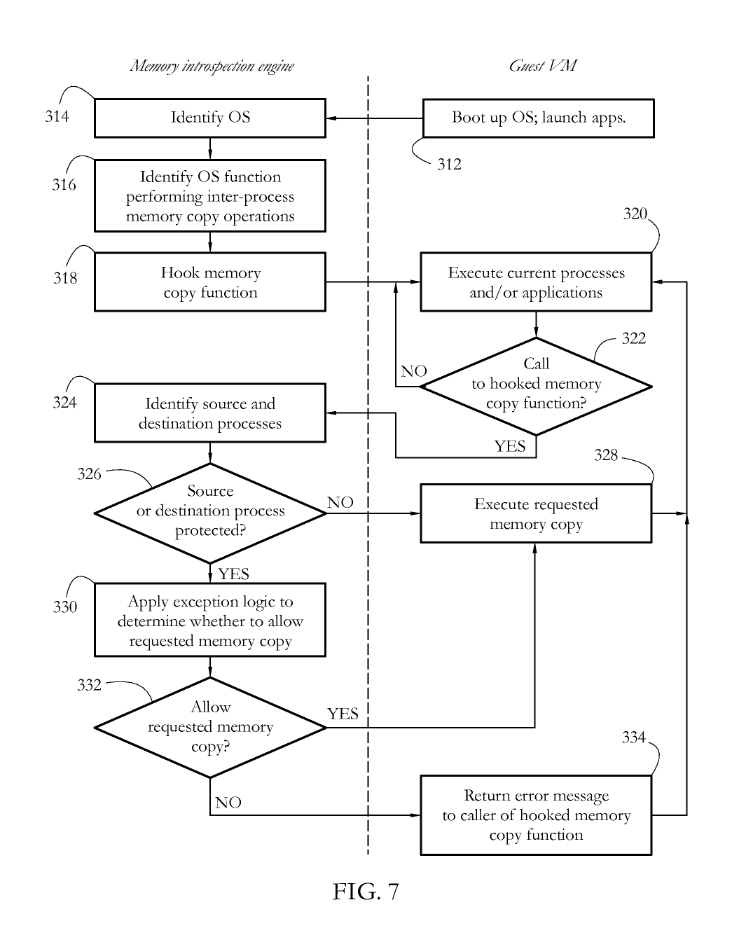

FIG. 7 shows an exemplary sequence of steps performed by memory introspection engine 40 to protect guest VM 32 from malware according to some embodiments of the present invention. Engine 40 may be configured protect a plurality of virtual machines executing concurrently on host system 10. The steps illustrated in FIG. 7 may be repeated for each such virtual machine. Following the initialization of guest OS 34 (step 312), in a step 314, introspection engine 40 may identify the type of OS currently running within guest VM 32. Exemplary OS types include Windows, Linux, MacOS, and Android, among others. OS type may further comprise a version indicator, such as 7, Home, or Enterprise, among others. In some embodiments, step 314 comprises listening from outside guest VM 32 for processor events indicative of OS initialization. Instructions that perform OS initialization operations typically require substantial processor privileges, e.g., ring 0 on Intel platforms. Processor 12 may be configured by hypervisor 30 so that the execution of such instructions triggers a virtual machine exit event (e.g., VMExit on Intel® platforms), which transfers control of processor 12 from OS 34 to hypervisor 30. By intercepting such events, introspection engine 40 may thus receive information about the initialization of guest OS 34.

In an illustrative embodiment, engine 40 may intercept an attempt by guest OS to write to a model-specific register (MSR) of guest VM 32, and identify the type of OS according to a content of the respective MSR, according to a section of memory pointed to by the respective MSR, or according to a parameter of the write instruction. Exemplary MSRs which may allow identification of the OS include, among others, a SYSENTER/SYSCALL MSR. Engine 40 may further use pattern matching against a pre-determined library of fast system-call handlers specific to each OS (e.g., system calls handled according to a content of the SYSCALL or SYSENTER MSRs). Such fast system-call libraries may be provided with memory introspection engine 40, and may be kept up to date via periodic or on-demand software updates. In some embodiments, a version indicator (such as a release name, build number, etc.) may be obtained by parsing certain kernel data structures specific to the respective type of OS. Exemplary data structures allowing identification of OS version are certain export symbols of the Linux kernel or certain exported symbols of the Windows kernel, such as the NtBuildNumber, among others.

Once the type of OS is identified, in a step 316, engine 40 may identify a native OS function performing inter-process copying of code and/or data within guest VM 32. An exemplary function carrying out such operations in a Windows® environment is MmCopyVirtualMemory. Identifying the respective function may include, for instance, determining a memory address of the function, which may be achieved, for instance, by parsing certain OS-specific data structures, such as the exported functions tables of the kernel binary images (e.g. Portable Executable in Windows, Executable and Linkable Format in Linux). Another exemplary manner of identifying the native OS function is by parsing its code in search for a set of identifying patterns.

In a step 318, engine 40 may proceed to modify the native OS function to provide it with additional functionality. Such modifications may be achieved using any hooking method known in the art. For instance, engine 40 may apply a re-direction patch, such as a VMCall instruction or a JMP instruction, over-written or added to the respective native OS function. Other embodiments may modify an EPT entry of the respective OS function, to point to a new address. In some embodiments, the effect of such hooking is to redirect execution of the native OS function responsible for inter-process memory copying operations to a fragment of code provided by engine 40; exemplary functionality of such code is given below (steps 324-334). Following hooking, when OS 34 attempts to copy a content of memory between two processes, the respective fragment of code will be executed before or instead of the code of the native OS function.

Introspection engine 40 may now return control of processor 12 to guest VM 32. In a sequence of steps 320-322, guest VM 32 may execute current processes and/or applications until one such process issues a call to the OS function hooked in step 318. The call is intercepted via the hooking mechanism, suspending execution of guest VM 32 and transferring execution to introspection engine 40.

In a step 324, engine 40 may identify a source process and a destination process of the intercepted memory copy operation, for instance, according to parameters or arguments of the intercepted function call. A step 326 may determine whether either the source or the destination process requires malware protection, i.e., is part of protected area 38 (FIG. 4). Step 326 may comprise, for instance, looking up the source and/or destination process within the list of protected processes. When neither the source, nor the destination process require protection, in a step 328 engine 40 returns execution to the native OS function, to carry out the respective memory copy operation.

When either the source process or the destination process requires protection, in a step 330, engine 40 may apply a set of criteria to determine whether the respective memory copy operation should be allowed. In some embodiments, step 330 comprises determining whether the respective memory copy operation is malware-indicative, as opposed to legitimate. There may be various situations in which copying memory from one process to another is legitimate. For instance, when launching a child process, a parent process may legitimately inject code and/or data into the child process. In another example, some system processes (i.e., processes of guest OS 34) may legitimately inject code/data into other processes.

Other exemplary criteria for determining whether to allow the memory copy include, among others, an owner of the source and/or destination process, a source address and/or a destination address of the memory section being copied, a size, and a content of the respective section of memory. In one example, engine 40 may determine, according to a content and/or to an address of the respective memory section, what kind of resource is being copied between the source and destination processes. One such exemplary resource is a library (e.g., a dynamic-linked library, or DLL in Windows®). In another example, engine 40 may determine according to a destination address what part of the destination process will receive the copied content. For instance, engine 40 may determine whether the injected code/data will be copied to a region of memory allocated for the stack or the heap of the destination process. An attempt to write to such memory regions may be malware-indicative.

When a step 332 determines that the memory copy should be allowed, introspection engine 40 returns execution to the native OS memory copy function (step 328). When no, a step 334 may block the respective memory copy operation. For instance, step 334 may return an error (e.g., STATUS_ACCESS_DENIED) to a caller of the memory copy function. In some embodiments, step 334 may further comprise alerting a system administrator and/or displaying a warning to a user of guest VM 32.

A skilled artisan will appreciate that, while FIG. 7 shows steps 324-326-330-332 executing outside guest VM 32, such steps may be also carried out from within guest VM 32. In one such example, engine 40 may inject a fragment of code providing the functionality of said steps into a memory space used by VM 32, and configure the hook (step 318 above) to redirect execution to the injected code.

The exemplary systems and methods described above allow protecting a computer system from malware using hardware virtualization technology. In some embodiments, a hypervisor operates at the highest level of processor privilege (e.g., ring-1 or root mode), and displaces the operating system to a virtual machine. An introspection engine executes at the level of the hypervisor, i.e., below all virtual machines exposed on the host system, thus performing anti-malware activities from a position of higher privilege than the operating system. The introspection engine may block the illegitimate copying of code and/or data to and/or from the memory space of a protected process executing within a virtual machine, thus preventing malicious code injection and/or data theft. A single such introspection engine may protect multiple virtual machines operating on the same hardware platform. In some embodiments, protected processes execute at user-level of processor privilege (e.g., ring 3 or user mode).

In some embodiments, to prevent inter-process copying of code and/or data, the introspection engine may hook a native OS function performing inter-process memory copy operations, and redirect execution of the native OS function to a fragment of code executing outside the respective VM, at the privilege level of the hypervisor. Alternatively, the fragment of code executes within the respective VM, and is injected into the memory of the respective VM from the level of the hypervisor. The fragment of code may determine whether to allow the respective memory copy operation according to a set of criteria, such as the identity of the source and/or destination process, the owner of the source and/or destination process, the size, and the content of the copied section of memory. When a decision is made to allow the copying of memory between the source and destination process, the introspection engine may return execution to the native OS function. When the copying is not allowed, the introspection engine may simply block the copy operation, for instance by returning an error to a caller of the native OS function.

Conventional anti-malware solutions are typically tailored to a single operating system. Switching between one operating system and another may require loading a different version of anti-malware software. In contrast, in some embodiments of the present invention, the same memory introspection engine may malware-protect the respective computer system, irrespective of the type and version of operating system is currently running. By executing the memory introspection engine at the level of a hypervisor, and by displacing the operating system to a virtual machine, some embodiments may run and protect several operating systems concurrently. In some embodiments, the memory introspection engine may dynamically identify each operating system, for instance on boot-up, and may further protect OS-specific software objects and data structures.

It will be clear to a skilled artisan that the above embodiments may be altered in many ways without departing from the scope of the invention. Accordingly, the scope of the invention should be determined by the following claims and their legal equivalents.

What is claimed is:

1. A host system comprising a hardware processor configured to operate:
a virtual machine comprising a virtualized processor, the virtual machine configured to employ the virtualized processor to execute a source process and a destination process; and
a memory introspection engine executing outside the virtual machine and configured to:
intercept an attempt to copy a content of memory from a virtual memory space of the source process to a virtual memory space of the destination process;
identify the source and destination processes according to the attempt; and
in response to identifying the source and destination process, selectively block the attempt according to a selection criterion determined according to at least one member of a group consisting of an identity of the source process and an identity of the destination process.

2. The host system of claim 1, wherein intercepting the attempt comprises modifying a memory management function of an operating system executing within the virtual machine, the modification causing the hardware processor to switch from executing the memory management function to executing the memory introspection engine in response to the attempt.

3. The host system of claim 1, wherein intercepting the attempt comprises detecting a call to a memory management function of an operating system executing within the virtual machine, the memory management function carrying inter-process memory copying operations.

4. The host system of claim 1, wherein the memory introspection engine is configured to malware-protect a set of target processes executing within the virtual machine, and wherein selectively blocking the attempt comprises determining whether the source process belongs to the set of target processes.

5. The host system of claim 1, wherein the memory introspection engine is configured to malware-protect a set of target processes executing within the virtual machine, and wherein selectively blocking the attempt comprises determining whether the destination process belongs to the set of target processes.

6. The host system of claim 1, wherein selectively blocking the attempt comprises:
determining a destination address for the content within the memory space of the destination process; and
determining whether to block the attempt according to the destination address.

7. The host system of claim 6, wherein determining whether to block the attempt comprises identifying a type of resource of the destination process currently residing at the destination address.

8. The host system of claim 1, wherein the selection criterion is further determined according to an owner of the source process.

9. The host system of claim 1, wherein the selection criterion is further determined according to the content of memory.

10. The host system of claim 1, wherein the selection criterion is further determined according to whether the destination process is a child of the source process.

11. The host system of claim 1, wherein selectively blocking the attempt comprises:
determining whether the attempt is malware-indicative according to the selection criterion; and
in response:
when the attempt is not malware-indicative, allowing the execution of the attempt; and
when the attempt is malware-indicative, returning an error to an entity performing the attempt.

12. A method comprising employing at least one hardware processor of a host system to execute a memory introspection engine, the memory introspection engine executing outside of a virtual machine exposed by the host system, the virtual machine comprising a virtualized processor and configured to employ the virtualized processor to execute a source process and a destination process, and wherein executing the memory introspection engine comprises:
intercepting an attempt to copy a content of memory from a virtual memory space of the source process to a virtual memory space of the destination process;
identifying the source and destination processes according to the attempt; and
in response to identifying the source and destination processes, selectively blocking the attempt according to a selection criterion determined according to at least one member of a group consisting of an identity of the source process and an identity of the destination process.

13. The method of claim 12, wherein intercepting the attempt comprises employing the memory introspection engine to modify a memory management function of an operating system executing within the virtual machine, the modification causing the hardware processor to switch from executing the memory management function to executing the memory introspection engine in response to the attempt.

14. The method of claim 12, wherein intercepting the attempt comprises detecting a call to a memory management function of an operating system executing within the virtual machine, the memory management function carrying inter-process memory copying operations.

15. The method of claim 12, wherein the memory introspection engine is configured to malware-protect a set of target processes executing within the virtual machine, and wherein selectively blocking the attempt comprises determining whether the source process belongs to the set of target processes.

16. The method of claim 12, wherein the memory introspection engine is configured to malware-protect a set of target processes executing within the virtual machine, and wherein selectively blocking the attempt comprises determining whether the destination process belongs to the set of target processes.

17. The method of claim 12, wherein selectively blocking the attempt comprises:
determining a destination address for the content within the memory space of the destination process; and
determining whether to block the attempt according to the destination address.

18. The method of claim 17, wherein determining whether to block the attempt comprises identifying a type of resource of the destination process currently residing at the destination address.

19. The method of claim 12, wherein the selection criterion is further determined according to an owner of the source process.

20. The method of claim 12, wherein the selection criterion is further determined according the content of memory.

21. The method of claim 12, wherein the selection criterion is further determined according to whether the destination process is a child of the source process.

22. The method of claim 12, wherein selectively blocking the attempt comprises:
determining whether the attempt is malware-indicative according to the selection criterion; and
in response:
when the attempt is not malware-indicative, allowing the execution of the attempt; and
when the attempt is malware-indicative, returning an error to an entity performing the attempt.

23. A non-transitory computer-readable medium storing instructions which, when executed by at least one hardware processor of a host system, cause the host system to form a memory introspection engine executing outside a virtual machine exposed by the host system, wherein the virtual machine comprises a virtualized processor, wherein the virtual machine is configured to employ the virtualized processor to execute a source process and a destination process, and wherein the memory introspection engine is configured to:
intercept an attempt to copy a content of memory from a virtual memory space of the source process to a virtual memory space of the destination process;
identify the source and destination processes according to the attempt; and
in response to identifying the source and destination processes, selectively block the attempt according to a selection criterion determined according to at least one member of a group consisting of an identity of the source process and an identity of the destination process.
